(19) United States
(12) Patent Application Publication
(10) Pub. No.: US 2015/0286996 A1
(43) Pub. Date: Oct. 8, 2015

(54) METHOD AND APPARATUS FOR CARRYING OUT AN ELECTRONIC TRANSACTION

(71) Applicant: FORTNUM PTE. LTD., Singapore (SG)

(72) Inventor: Cheh Ngee Goh, Singapore (SG)

(73) Assignee: Fortnum Pte. Ltd., Singapore (SG)

(21) Appl. No.: 14/646,207

(22) PCT Filed: Oct. 21, 2013
(86) PCT No.: PCT/SG2013/000452

§ 371 Date: May 20, 2015

(30) Foreign Application Priority Data
Nov. 20, 2012 (SG) 201208561-9

(51) Int. Cl. G06Q 20/08; G06Q 20/20; G06Q 20/32; G06Q 30/06

(52) U.S. Cl. CPC G06Q 20/0855; G06Q 30/0619; G06Q 20/202; G06Q 20/322

(57) ABSTRACT

There is provided a method for carrying out an electronic transaction involving use of a digital payment reference between a merchant, a consumer and a trusted party. There is provided an apparatus for carrying out an electronic transaction involving use of a digital payment reference. The method and apparatus minimises risk to a consumer regardless of whether the transaction is carried out either in a physical or virtual setting.

### FIELD OF INVENTION

The present invention relates to a method and an apparatus for carrying out an electronic transaction, particularly electronic transactions involving a merchant, a consumer and at least one intermediate entity.

### BACKGROUND

Transactions are usually carried out whenever goods/services are offered either in a physical or virtual setting. Regardless of setting, it is becoming increasingly common that transactions are carried out using card-based payment methods. Such card-based payment methods are generally convenient for both merchants and consumers. However, use of card-based payment methods is typically associated with an element of risk for the consumer. Issues of known card-based payment methods are provided in the following paragraphs.

In an over-the-counter transaction, a consumer hands over the requisite card to a merchant. Subsequently, communications with a credit entity (for example, a bank) are carried out to obtain authorisation from the bank and the consumer then confirms payment either by input of a personal identification number (PIN), or by providing a signature to the merchant. Issues for such a transaction include, for example, a need for the consumer to provide the requisite card, a need for the requisite card to be undamaged to carry out the transaction, a need for the merchant to input transaction details accurately, risk of “skimming” (capture of critical payment information stored on a magnetic strip of a credit/debit card) and the like.

When using near field communications (NFC) for tap-and-go card transactions, only the consumer handles the requisite card and correspondingly, the payment process is faster and less likely to be compromised. However, once the requisite card is stolen, unauthorised use can be carried out rapidly which causes substantial losses to either the consumer or to credit entities. Furthermore, the use of NFC requires a reader device which is not readily available due to both cost and lack of a standardised NFC protocol.

For over-the-phone or over-the-fax transactions, a consumer provides details of the requisite card to a merchant in order for the transaction to be carried out. In such instances, the details can be misappropriated by the merchant, or the details may be incorrectly provided to the credit entities due to errors by the consumer/merchant.

With regard to online transactions, most merchants engage payment service providers such as, for example, Worldpay®, Globalpay®, PayPal®, Ferbuy®, and the like. A consumer is required to input details of the requisite card (or an associated email address in the case of PayPal®) when transacting with the online merchant. The details may be incorrectly input, and there are risks when transacting on computers which have been compromised with, for example, key-loggers, Trojan software which captures the critical payment information, “man-in-the-browser” software which redirects payment to undesired recipients and so forth. Furthermore, it is also tedious for the consumer to repeatedly input shipping information, to the merchant. Merchants who store consumers' information to enable convenient transactions, such as Amazon.com® must ensure that the stored information is secure. This incurs substantial expenditure which is beyond the financial means of small-scale merchants.

Recently, a start-up company called “Square” facilitates the carrying out of transactions by storing a consumer's credit card information. In an over-the-counter transaction, as long as the consumer has activated a “Square” app on the consumer's mobile phone and a location of the mobile phone (as correspondingly, consumer) is deemed to be in close proximity to the merchant, payment is then made through “Square” upon confirmation by the consumer to the merchant. However, the value of such a transaction is unlikely to be substantial because of the lack of control by the consumer and it is not usable for online transactions.

Another start-up company called “Kuapay”, requires the consumer to present a reference ID on the smart phone to the merchant at the checkout, so that the merchant can capture the ID and make a request to a server to request payment. The request will return to the consumer's phone and allows the consumer to approve. While this improves consumer control of the transaction, loss or theft of the smart phone can lead to abuse of the reference ID on the smart phone, and the method is not replicated easily to online or remote merchant situations such as, for example, billboard advertisements, video messages and so forth.

Other alternatives like, for example, Paypal Here®, GoPayment® and Groupon® use a card-swipe peripheral device attachable to a mobile phone, so that the mobile phone behaves in a similar manner to a mobile phone installed with the “Square” app. However, these alternatives also expose a consumer to the risk of skimming.

Other entities like BrainTree®, Stripe® and FeeFighter® aim to provide electronic transaction capabilities for online merchants, but none of these entities focus on managing risks for consumers with regard to electronic transactions.

Referring to the aforementioned processes, it should be appreciated that in order for payment to take place, the consumer typically provides information to the merchant to ensure that the merchant can get a guarantee of payment from the credit entity. When the information is in transit, either physically (stored in the card) or virtually (data bytes containing the information), there are risks where the information is wrongfully intercepted which invariably lead to many adverse issues.

### SUMMARY

In a first aspect, there is provided a method for carrying out an electronic transaction involving use of a digital payment reference between a merchant, a consumer and a trusted party. The method includes receiving the digital payment reference at a portable communication device of the consumer; transmitting the digital payment reference from the portable communication device to at least one server of the trusted party; processing the digital payment reference at the at least one server of the trusted party to carry out the transaction; and transmitting notifications to the merchant and the consumer of a status of the transaction being carried out. The at least one server of the trusted party may include a transaction server and a payment server.

It is preferable that the digital payment reference is in a form like, for example, an alphanumeric string, a barcode, audio signals and so forth. The digital payment reference can include a merchant identity and an amount of the transaction. The digital payment reference can be a payment token which includes a limit for the transaction amount and may also include an authorization step to enable the transaction to be carried out.

Preferably, the transmission of the digital payment reference from the portable communication device to at least one server of the trusted party includes input of either a′ password or a PIN.

It is preferable that the processing of the digital payment reference includes recording both successful and failed transactions. Similarly, the status of the transaction is either successful or failed.

In one embodiment, the digital payment reference is received when the digital payment reference is generated by either the portable communication device or an enterprise device of the merchant. In a second embodiment, the digital payment reference is received from an advertisement for either a product or a service, the advertisement being in a form of, for example, print media, video media, audio media and so forth. In a third embodiment, the method can also further include generating the digital payment reference at the trusted party, transmitting the digital payment reference to an enterprise device of the merchant; and conveying the digital payment reference from the enterprise device.

The enterprise device may be, for example, a tablet computer, a desktop computer, a point of sale terminal, at least one server and the like. The portable communication device may be, for example, a wearable mobile communication device, a mobile phone, a tablet computer, a notebook computer and so forth.

It is preferable that the portable communication device is configured to process the digital payment reference to carry out at least one task such as, for example, display information relating to the transaction to the consumer, check on the consumer's benefits and restrictions with the trusted party and the like.

The method can also include selecting a payment type for the transaction, the payment type including data stored with either the consumer or the trusted party.

It is advantageous that tampering of the digital payment reference causes a failed transaction, the tampering being carried out by malware.

Preferably, the consumer and the merchant are associated with the trusted party.

It is preferable that an aggregator consolidates at least two of the steps of the method such as, for example, receiving the digital payment reference, receiving the consumer's benefits and restrictions regarding the transaction, receiving a desired payment type, receiving confirmation of close proximity of both the merchant and the consumer and the like.

In a second aspect of the invention, there is provided an apparatus for carrying out an electronic transaction involving use of a digital payment reference. The apparatus includes a data transceiver configured to receive usage information relating to the electronic transaction; a digital database configured to store the usage information received from the data transceiver; and a processor configured to process provision of the usage information stored in the digital database for determining if the electronic transaction is at a stage to proceed on to processing by a payment server.

It is preferable that the data transceiver is configured to receive and transmit data either wirelessly or via a cabled connection.

Preferably, the usage information is at least one item selected from, for example, the digital payment reference, a consumer's benefits and restrictions regarding the transaction, a desired payment type, confirmation of close proximity of both a merchant and the consumer and so forth. The usage information may be transmitted from a portable communication device installed with an “app”.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIG. 1 shows a first part of a process flow for a preferred embodiment of a method of the present invention.

FIG. 2 shows a second part of a process flow for the preferred embodiment of the method of the present invention.

FIG. 3 shows a third part of a process flow for the preferred embodiment of the method of the present invention.

FIG. 4 shows a process flow being carried out in the server of FIG. 2.

FIG. 5 shows a system for the present invention.

FIG. 6 shows an example of a process carried out by an aggregator of the present invention.

FIG. 7 shows a schematic view of the aggregator of FIG. 6.

### DESCRIPTION OF PREFERRED EMBODIMENTS

The present invention relates to a method and an apparatus for carrying out a transaction in a manner which minimises risk to a consumer regardless of whether the transaction is carried out either in a physical or virtual setting.

In a preferred embodiment for the present invention, referring to FIG. 5, there is a minimum of three parties involved in a system 18 for carrying out a transaction. They are a merchant 20, a consumer 22, and an intermediate entity which shall be termed as a Trusted Party (TP) 24. The TP 24 operates at least one server 26 and runs services using the at least one server 26. The TP 24 may have a secure communications channel(s) with banks, card issuing institutions, and entities which are involved in transactions pertaining to cards or fund transfers. Further details of the at least one server 26 will be provided in a subsequent portion of the description.

Both the merchant 20 and the consumer 22 are respectively associated with the TP 24. The merchant 20 uses an enterprise device 29 and the consumer 22 uses a portable communication device 28 for communication with the at least one server 26 of the TP 24. The portable communication device 28 can be, for example, a mobile phone, a tablet computer, a notebook computer and the like. The enterprise device 29 can be, for example, a tablet computer, a desktop computer, a point of sale terminal, at least one server and so forth.

The portable communication device 28 may be wearable and should be able to capture data. For example, the portable communication device 28 may include a camera for capturing visual indicia (for example, barcodes, QR codes, etc) and subsequently obtaining the data embedded in the visual indicia using known software running on the communication device 28. The portable communication device 28 may also include Optical Character Recognition (OCR) functionality to obtain data embedded in alpha-numeric character strings. Similarly, the portable communication device 28 may include a microphone to obtain data embedded in audio signals.

The enterprise device 29 should be able to transmit data, either by display of visual indicia/alphanumeric character strings, or reproduction of audio signals. The display of visual indicia/alphanumeric character strings can be carried out either on a screen or reproduced in a printed form. It should be appreciated that a printer may be coupled to the communication device 29 in order to reproduce the visual indicia/alphanumeric character strings in a printed form.

As mentioned in a preceding paragraph, both the merchant 20 and the consumer 22 are respectively associated with the TP 24. The consumer 22 provides at least some of a credit/charge/debit/prepaid card(s) details with the TP 24. The consumer 22 may also authorize the TP 24 to withdraw funds from a bank account(s) belonging to the consumer 22. Furthermore, the consumer may also deposit funds with the TP 24 as buffer funds in case of issues with the credit card(s) and the bank account(s). Correspondingly, the consumer 22 is assigned a payer account identity once the consumer 22 is associated with the TP 24. The consumer 22 is subsequently identified solely by the payer account identity.

Similarly, the merchant 20 provides the TP 24 with details of a bank account(s) such that the TP 24 is able to deposit funds into the bank account(s). Where the merchant 20 has a merchant account with an issuing institution for credit/charge/debit/prepaid cards, the merchant account details are provided to the TP 24, and the merchant 20 authorises the TP 24 to interact with the issuing institution on behalf of the merchant 20. Correspondingly, the merchant 20 is assigned a payee account identity once the merchant 20 is associated with the TP 24. The merchant 20 is subsequently identified solely by the payee account identity.

The aforementioned information provided to the TP 24 by the consumer 22 and the merchant 24 is securely stored in the at least one server 26 of the TP 24. It will be evident in subsequent sections of the description that the information stored in the at least one server 26 will not be transmitted during the course of any transaction.

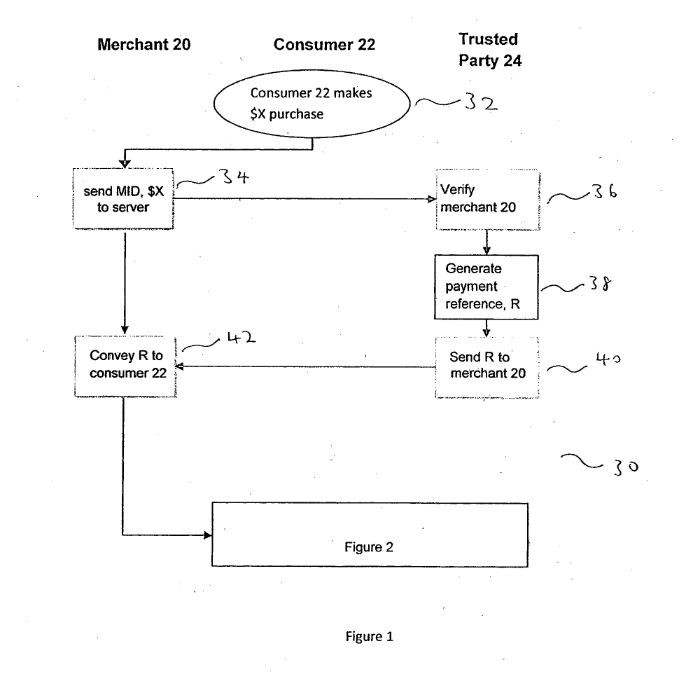

It should be noted that a combination of FIGS. 1 to 4 illustrate a method 30 for carrying out an electronic transaction either in a physical or virtual setting. Reference will be made to the appropriate Figure when describing various portions of the method 30.

Referring to FIG. 1, there is shown a start of the method 30. The consumer 22 makes a $X transaction for goods/services (32), and the enterprise device 29 of the merchant 20 sends a token including the payee account identity of the merchant 20 (MID) together with an amount of the transaction, $X to the at least one server 26 of the TP 24 (34). The at least one server 26 of the TP 24 receives the token and verifies that merchant 20 (36). The at least one server 26 then generates an associated payment reference, R for the token (38) and transmit the payment reference, R to the enterprise device 29 of the merchant 20 (40). The payment reference, R is in a form such as, for example, an alphanumeric string, a barcode, audio signals and so forth. The payment reference, R, also includes the MID together with an amount of the transaction, $X. It should be appreciated that the token is stored at the at least one server 26 of the TP 24 such that the payment reference, R will be used to cross-reference the stored token at a subsequent juncture.

The payment reference, R is conveyed to the portable communication device 28 of the consumer 22 by the merchant 20 (42). The conveyance of R can be carried out by, for example, manual input of a text string into the portable communication device 28 by the consumer 22, screen image capture using the portable communication device 28 by the consumer 22, scanning visual indicia (in a 10 format or a 2D format) using the portable communication device 28 by the consumer 22, capturing audio signals using the portable communication device 28 by the consumer 22, and so forth. It is appreciated that the portable communication device 28 includes software capable of processing the payment reference, R. The software may also be known as an “app”. The software could be either pre-installed at a point of manufacture or installed at any juncture by the consumer 22.

In an alternative embodiment, R need not be generated by the TP 24. Instead, R is a generated in the portable communication device 28 by a consumer version of the “app” when a location of both the merchant 20 (obtained when the MID is input into the portable communication device 28) and the consumer 22 are in close proximity within a predetermined tolerance limit. It should be noted that the amount of the transaction, $X should also be input into the portable communication device 28 to enable R to be generated.

In yet another alternative embodiment, R is generated by the merchant 20 on the enterprise device 29. The enterprise device 29 is also installed with a merchant version of the “app”. The merchant version of the “app” will have a specific MID of the merchant 20, such that when the merchant 20 inputs the amount of the transaction, $X, the R which is generated includes the MID of the merchant.

For illustrative purposes, an example is provided for use of the method 30 in a physical setting. When the consumer 22 is at a point-of-sale counter of a merchant 20, a cashier at the point-of sale counter with the enterprise device 29 sends a token to the TP 24 using the enterprise device 29. Consequently, the TP 24 sends payment reference, R to the enterprise device 29 of the merchant 20, and the consumer 22 uses the portable communication device 28 to obtain the payment reference, R from the enterprise device 29. Another example is provided for use of the method 30 in a virtual setting. When the consumer 22 is at a checkout portal of an online merchant 20, the consumer 22 initiates payment which causes the online merchant 20 to send a token to the TP 24 using the enterprise device 29. Consequently, the TP 24 sends payment reference, R to the enterprise device 29 of the merchant 20, and the consumer 22 uses the portable communication device 28 to obtain the payment reference, R.

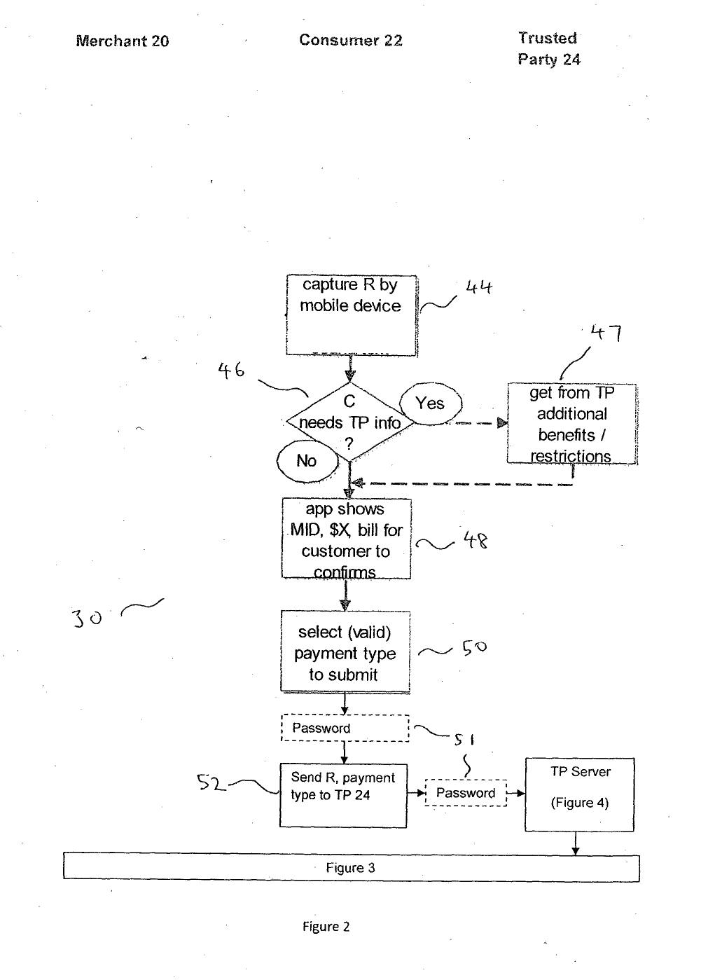

Referring to FIG. 2, when R is captured by the portable communication device 28 (44), the software processes R to obtain information usable for two purposes. The first purpose is to display information relating to the transaction to the consumer 22 on the portable communication device 28 for confirmation by the consumer 22 (48). The second purpose is for an optional check on the consumer's 22 benefits and restrictions with the TP 24 (46). The benefits for the consumer 22 include, for example, discounts from certain merchants, privileges from certain merchants, services from certain merchants and so forth. The restrictions for the consumer 22 include, for example, limited payment options because of merchant preferences, limited payment options because of bank policies, and so forth. The benefits and restrictions for the consumer can be obtained by the TP 24 from third parties (47), such as, for example, banks, card issuing institutions, merchants and so forth. It should be appreciated that the benefits are associated with the payer account identity of the consumer 22.

At this juncture of the method 30, the consumer 22 selects a payment type for the transaction (50) based on available options in accordance with the payer account identity of the consumer 22. Selection of the payment type can include obtaining data from either the consumer 22 (on the portable communication device 28) or the TP 24 (on the at least one server 26), the data being for use in subsequent junctures of the transaction.

Subsequently, R and the payment type are transmitted to the TP 24 (52), and the consumer may be required to enter a password/PIN (51) either before or after the transmission to allow the transmission to be carried out. As described earlier, obtaining data from the portable communication device 28 during selection of the payment type can minimise an amount of data which the TP 24 will seek in the course of the transaction. This authentication mechanism may reside at either the “app” or the at least one server 26 of the TP 24, and the primary purpose is for ensuring that the person submitting R and the payment type is the appropriate person.

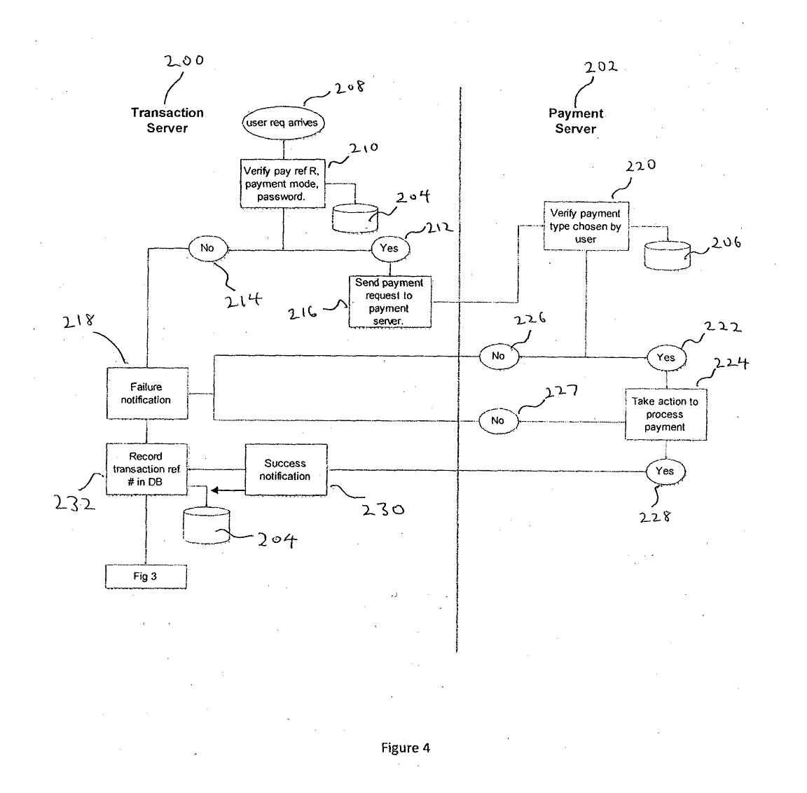

Referring to FIG. 4, the at least one server 26 of the TP 24 can be broken down into a transaction server 200, and a payment server 202. The transaction server 200 includes a transaction database 204, while the payment server 202 includes a payment database 206.

When R, payment type and the password are received at the at least one server 26, it is channeled to the transaction server 200 (208). The R, payment type and the password are verified with data stored in the transaction database 204 (210). The transaction database 204 stores non-payment related data associated with the payer account identity of the consumer 22 and the payee account identity of the merchant 20. It should be noted that in any event when malware modifies R, a mismatch will result which is impermissible. If the R, payment type and the password are permissible (212), a payment request is generated and transmitted to the payment server 202 (216). The payment request includes the payment type and the amount of the transaction. If the R, payment type and the password are not permissible (214), the process fails (218).

When the payment request is received by the payment server 202, the payment type will be verified with data stored in the payment database 206 (220). The payment database 206 stores payment related data associated with the payer account identity of the consumer 22 and the payee account identity of the merchant 20. If the payment type can be utilized (222), known processes are implemented to carry out payment (224). These known processes are as per how a merchant carries out payment in online transactions in the merchant's online portal. If the payment type cannot be utilized (226), the process fails and failure notification is generated (218). If the known processes to carry out payment fail (227), the process fails and failure notification is generated (218).

If the payment is processed by the banks or financial institutions and approved (228), an outcome is returned to the transaction server 200 together with a success notification is generated (230). For example, an acquiring bank of the merchant 20 issues a transaction reference number for a credit card payment transaction, a paying bank of the consumer 22 issues a fund transfer approval reference for charging of the consumer's 22 account, a prepaid deposit service of the consumer 22 issues a transfer reference for an appropriate deduction to credit the merchant, and so forth. It may be possible to tag an indicator when generating the success notification (230) to denote if the transaction is successful. Both success and failure notifications are then stored in the transaction database 204 (232).

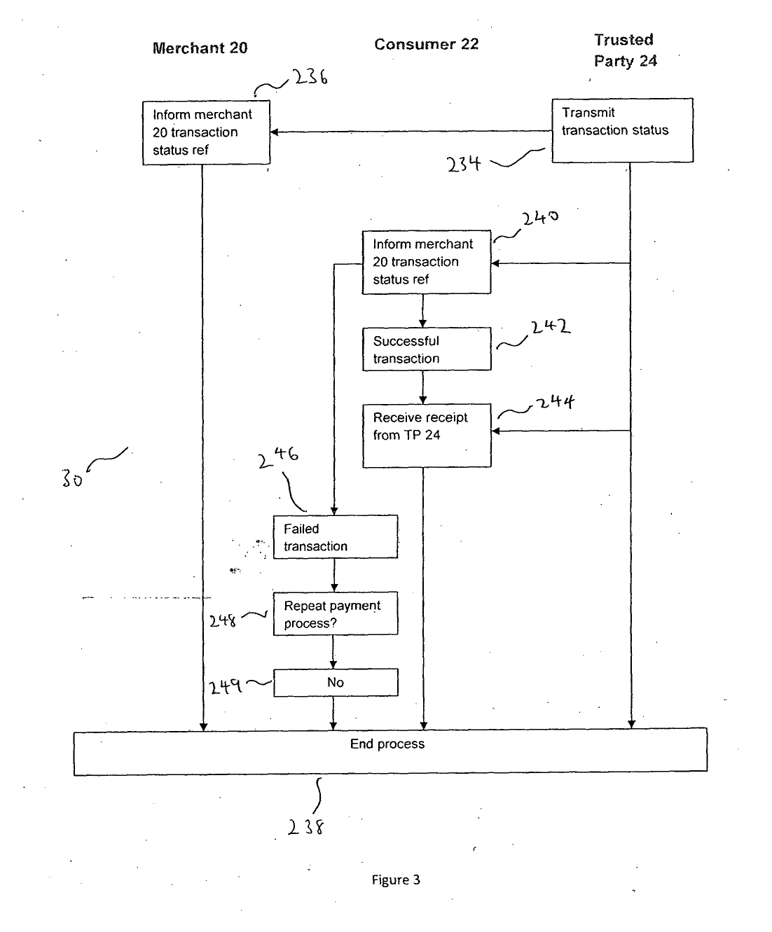

Subsequently, referring to FIG. 3, the success/failure notifications are transmitted to both the merchant 20 and the consumer 22 (234). Once the success/failure notifications are received by the merchant 20 (236), the merchant 20 knows if the transaction was successful and the process ends (238). Once the success/failure notifications are received by the consumer 22 (240), the consumer 22 knows if the transaction was successful. If the transaction was successful (242), the consumer 22 received a receipt from the TP 24 (244) and the process ends (238). If the transaction was unsuccessful (246), the consumer 22 then has an option to either repeat the method 30 (248) or not repeat the method 30 (249) and ending the process (238).

In this method 30, the merchant 20 (either in a physical or virtual setting) does not need to know the mode of payment for the transaction and “skimming” of cards cannot be carried out. The consumer 22 does not need to have a physical card at hand and does not need to divulge any card information in order to carry out a transaction.

One variation for the method 30 relates to how the consumer 22 firstly obtains the success notification 230 for an amount for the transaction. The consumer 22 then transmits a payment token which includes the success notification 230 to the merchant 20. The merchant 20 consequently utilises the payment token to obtain payment through TP 24 in the same manner as described in the preceding paragraphs, whereby R is replaced with the payment token. Transmission of the payment token from the portable communication device 28 of the consumer 22 to the enterprise device 29 of the merchant 20 is similar to how R was conveyed from the enterprise device 29 of the merchant 20 to the portable communication device 28 of the consumer 22 as described in the preceding paragraphs. There may be checks to verify the payment token prior to transmission to the TP 24.

The aforementioned variation is particularly useful in an instance of a future payment or recurring payments. Instead of obtaining a payment token associated specifically to an amount for the transaction, the consumer 22 can define the amount for the transaction to be variable up to a limit, and can also define if it is a one-off transaction or a recurring transaction for a specific number of instances. The merchant 20 receiving the payment token then submits the payment token together with transaction amount to the TP 24 at an agreed date/time to carry out the transaction. There may be an additional layer of security provided by the “app” whereby the consumer 22 is required to provide authorisation to enable completion of the transaction.

Having the additional layer of security is critical as the payment token can also be transferred amongst a plurality of consumers 22, whereby each consumer 22 has a portable communication device installed with the “app”. For example, a first consumer may need a second consumer to carry out a transaction on his behalf. After the first consumer transmits the payment token to the second consumer, the second consumer can use the payment token in a manner described in the previous paragraph. Authorization may be required from the first consumer to enable completion of the transaction, but the first consumer will be notified when the transaction is completed.

Another variation of the method 30 relates to how the consumer 22 is able to obtain R from an advertisement for a product(s) and/or a service(s), whereby the advertisement is in a form such as, for example, print media, video media, audio media and so forth. It should be appreciated that the consumer 22 is typically purchasing a product(s) and/or a service(s) shown/transmitted in the advertisement. In this variation, the consumer 22 is able to use the portable communication device 28 to obtain R. R is able to be obtained using the techniques described earlier, and it should be appreciated that this variation does not involve the merchant 20 (and the enterprise device 29) at the juncture when the consumer 22 is obtaining R. Thus, this variation described in this paragraph does away with the process flow shown in FIG. 1.

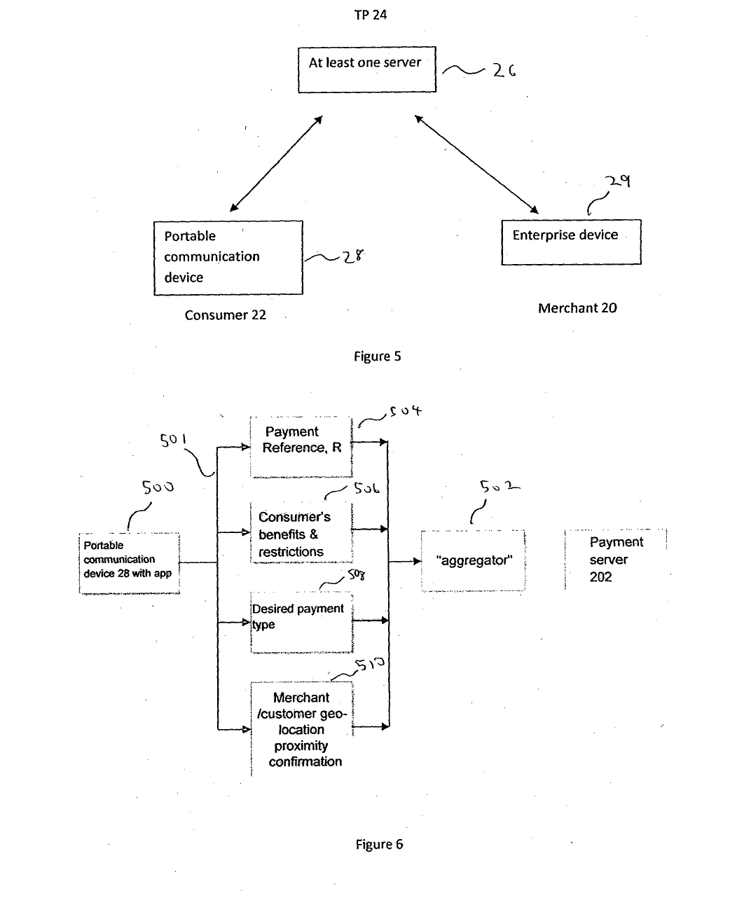

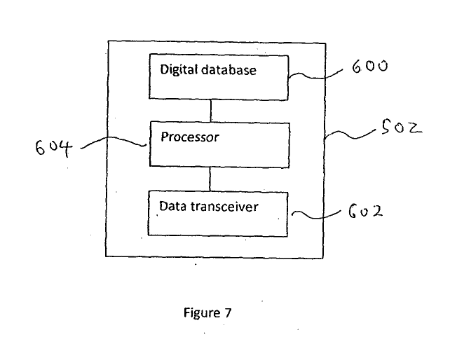

The aforementioned method 30 can be carried out with the use of an aggregator 502 as shown in FIGS. 6 and 7. The aggregator 502 can be a standalone server or a part of the at least one server 26 of the TP 24. The aggregator 502 is not shown in FIGS. 1 to 4 as it actually obtains usage information which has been discretely described with reference to FIGS. 1 to 4. As described in earlier paragraphs, the portable communication device 28 installed with the “app” (500) is able to transmit 501 the usage information such as, for example, R (504), consumer's 22 benefits and restrictions regarding the transaction (506), desired payment type (508), confirmation of close proximity of both merchant 20/consumer 22 (510) and so forth. It is appreciated that the confirmation of close proximity of both merchant 20/consumer 22 (510) can be viewed as a security safeguard.

Once the aggregator 502 receives the usage information via a data transceiver 602, the usage information is stored on a digital database 600. The data transceiver 602 can receive and transmit data either wirelessly or via a cabled connection. The aggregator 502 also includes a processor 604, to control all functions of the aggregator 502 and to process the usage information stored on the digital database 600. Once the processor 604 confirms that the usage information is duly provided from the portable communication device 28 installed with the “app” (500), the aggregator 502 determines the method 30 to be in at a stage which can proceed on to the processes described with regard to payment server 202.

It should be appreciated that in the present invention, once the consumer inputs pertinent details, such as, for example, credit card type, credit card number, expiry date and the like, the details are stored in a storage device that can be accessed remotely or locally (for eg. an intermediate entity payment server, a consumer's mobile device, and so forth), and will not be accessible to parties involved in a commercial transaction, regardless of whether the transaction is being carried out in a physical or virtual setting. Thus no unauthorised access of the pertinent information can occur. Furthermore, a merchant who already utilises existing card payment methods using point-of-sale card validation terminals need not invest on new equipment/infrastructure to use the present invention. In addition, the present invention provides a convenient payment solution for consumers in a physical or virtual setting which does away with a need to repeatedly provide pertinent details whenever a transaction takes place. Finally, the present invention also enables the consumer to entrust a proxy to carry out a transaction without any concern of the transaction being compromised in any manner.

Whilst there has been described in the foregoing description preferred embodiments of the present invention, it will be understood by those skilled in the technology concerned that many variations or modifications in details of design or construction may be made without departing from the present invention.

1. A method for carrying out an electronic transaction involving use of a digital payment reference between a merchant, a consumer and a trusted party, the method including:
receiving the digital payment reference at a portable communication device of the consumer;
transmitting the digital payment reference from the portable communication device to at least one server of the trusted party;
processing the digital payment reference at the at least one server of the trusted party to carry out the transaction; and
transmitting notifications to the merchant and the consumer of a status of the transaction being carried out.

2. The method as claimed in claim 1, wherein the digital payment reference is in a form selected from a group consisting of: an alphanumeric string, a barcode, and audio signals.

3. The method as claimed in either claim 1 or 2, wherein the digital payment reference includes a merchant identity and an amount of the transaction.

4. The method as claimed in any one of claims 1 to 3, wherein the transmission of the digital payment reference from the portable communication device to at least one server of the trusted party includes input of either a password or a PIN.

5. The method as claimed in any one of claims 1 to 4, wherein the at least one server of the trusted party includes a transaction server and a payment server.

6. The method as claimed in any one of claims 1 to 5, wherein the processing of the digital payment reference includes recording both successful and failed transactions.

7. The method as claimed in any one of claims 1 to 6, wherein the status of the transaction is either successful or failed.

8. The method as claimed in any one of claims 1 to 7, wherein the digital payment reference is received when the digital payment reference is generated by either the portable communication device or an enterprise device of the merchant.

9. The method as claimed in any one of claims 1 to 7, wherein the digital payment reference is received from an advertisement for either a product or a service, the advertisement being in a form selected from a group consisting of: print media, video media, and audio media.

10. The method as claimed in any one of claims 1 to 7, further including:
generating the digital payment reference at the trusted party,
transmitting the digital payment reference to an enterprise device of the merchant; and
conveying the digital payment reference from the enterprise device.

11. The method as claimed in claim 10, wherein the enterprise device is selected from a group consisting of: a tablet computer, a desktop computer, a point of sale terminal, and at least one server.

12. The method as claimed in any one of claims 1 to 11, wherein the portable communication device is selected from a group consisting of: a wearable mobile communication device, a mobile phone, a tablet computer, and a notebook computer.

13. The method as claimed in any one of claims 1 to 12, wherein the portable communication device is configured to process the digital payment reference to carry out at least one task selected from: display information relating to the transaction to the consumer, and check on the consumer's benefits and restrictions with the trusted party.

14. The method as claimed in any one of claims 1 to 13, further including selecting a payment type for the transaction, the payment type including data stored with either the consumer or the trusted party.

15. The method as claimed in any one of claims 1 to 14, wherein tampering of the digital payment reference causes a failed transaction, the tampering being carried out by malware.

16. The method as claimed in any one of claims 1 to 15, wherein the consumer and the merchant are associated with the trusted party.

17. The method as claimed in claim 1, wherein the digital payment reference is a payment token.

18. The method as claimed in claim 17, wherein the payment token includes a limit for the transaction amount.

19. The method as claimed in either claim 17 or 18, wherein the payment token includes an authorization step to enable the transaction to be carried out.

20. The method as claimed in any one of claims 1 to 19, wherein an aggregator consolidates at least two of the steps selected from the group consisting of: receiving the digital payment reference, receiving the consumer's benefits and restrictions regarding the transaction, receiving a desired payment type and receiving confirmation of close proximity of both the merchant and the consumer.

21. An apparatus for carrying out an electronic transaction involving use of a digital payment reference, the apparatus including:
a data transceiver configured to receive usage information relating to the electronic transaction;
a digital database configured to store the usage information received from the data transceiver; and
a processor configured to process provision of the usage information stored in the digital database for determining if the electronic transaction is at a stage to proceed on to processing by a payment server.

22. The apparatus as claimed in claim 21, wherein the data transceiver is configured to receive and transmit data either wirelessly or via a cabled connection.

23. The apparatus as claimed in either claim 21 or 22, wherein the usage information is at least one item selected from a group consisting of: the digital payment reference, a consumer's benefits and restrictions regarding the transaction, a desired payment type and confirmation of close proximity of both a merchant and the consumer.

24. The apparatus as claimed in any one of claims 21 to 23, wherein the usage information is transmitted from a portable communication device installed with an “app”.
